(19) United States
(12) Patent Application Publication
(10) Pub. No.: US 2014/0207661 A1
(43) Pub. Date: Jul. 24, 2014

(54) METHOD OF USING VIRTUAL MONEY

(71) Applicant: Ismail Ekmekçi, Seyhan (TR)

(72) Inventor: Ismail Ekmekçi, Seyhan (TR)

(21) Appl. No.: 14/161,040

(22) Filed: Jan. 22, 2014

(30) Foreign Application Priority Data
Jan. 24, 2013 (TR) 2013/00697

(51) Int. Cl. G06Q 20/06

(52) U.S. Cl. CPC G06Q 20/065
USPC 705/39

(57) ABSTRACT

A method of using virtual deposit money that can be created in exchange for certain guarantees and used in shopping is provided. The most important aspect of the method is to make it possible for the virtual money available in a credit card or any other card where data can be saved and which allows for identification, to be spent and then the related records to be deleted. The method additionally aims to provide the virtual money, itself, to be spent instead of the spending within the limitation, and to prevent spending when there remains no money to be spent. Distinctively from any kind of credit cards or gift cards with fixed limitation, the method of using virtual money provides to increase the limits of spending again thanks to the virtual money loaded subsequently.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a method of using virtual deposit money that can be created in exchange for certain guarantees and used in the shopping.

2. Description of Related Art Including Information Disclosed Under 37 CPR 1.97 and 37 CFR 1.98

With the spread of communication tools and the development of technology, shopping has started to be conducted on virtual medium by means of virtual cards and the limitations determined for these cards. Likewise, single-use cards with fixed limitation that cannot be increased, known as gift cards have been developed, and the shopping can be made through the POS device with these cards. The United States patent application numbered US2011270665 can be considered as an example of that. With each card allowing for spending according to the limit amount of money, the user can shop as he or she desires, by the total amount within the limit.

### BRIEF SUMMARY OF THE INVENTION

The most important object of the present invention is to make it possible for the virtual money available m a credit card or any other card where data can be saved and which allows for identification, to be spent and then the related records to be deleted. The present invention additionally aims to provide the virtual money, itself, to be spent instead of the spending within the limitation, and to prevent spending when there remains no money to be spent. Distinctively from any kind of credit cards or gift cards with fixed limitation, the present invention provides to increase the limits of spending again thanks to the virtual money loaded subsequently, according to the method of using virtual money.

### BRIEF DESCRIPTION OF THE SEVERAL VIEWS OF THE DRAWINGS

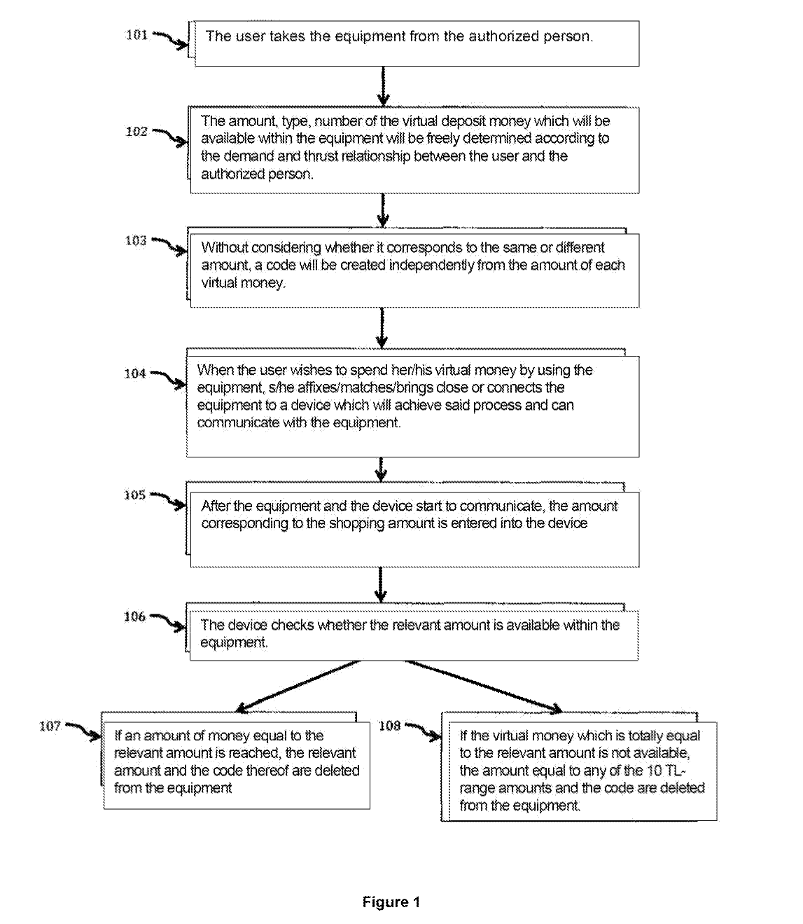

So as to achieve its objects, the method of using virtual deposit money is shown in the figures enclosed, where FIG. 1 is a flow chart of the method of using virtual deposit money according to the present invention.

### DETAILED DESCRIPTION OF THE INVENTION

In its basic form, the method of using virtual deposit money according to the present invention needs a medium where the data regarding the virtual money can be saved, updated and deleted. This medium needs to allow for data exchange and therefore tor communication during each shopping activity or episode. In this regard, credit cards with chip thereon, USB memories, NFC-comprising equipments, devices providing communication on IR or RF, any kind of equipment where a similar communication feature and an information-saving features are brought together can be used for saving the virtual money.

The information concerning the virtual deposit money is not only about the total balance of said virtual deposit money. Each virtual deposit money will be saved within this equipment either individually or by being matched with a certain code. The amounts, types (TL, USD, Euro, etc.) of said virtual money can be different from each other. Moreover, the virtual money itself or the codes thereof which can be different than the currently-used denominations on the market are created not by the user, but by another authority.

The authority loads the one-piece or multiple-piece virtual money to the equipment in accordance with the credit limits, deposit, credit level of the person to whom the equipment will be given, in the desired amount, number and type. And upon the spending of the person using the equipment, the virtual money starts to circulate within the market.

The present invention will provide the process mentioned briefly above to be conducted in accordance with the following method.

The process starts when the user takes the equipment from the athorized person (101). The amount, type, and number of the virtual deposit money which will be available within the equipment will be freely determined depending on the demand and thrust relationship between the user and the authorized person (102).

The virtual money to be loaded into the equipment may equal to same or different amounts. Without considering whether it is equal to the same or different amount, a code will be created independently from the amount of each virtual money (103).

The codes, on the other hand, can be created as same for the amount within a certain range, or they can be created differently. Each of these ranges can be equal to 1 USD cent for USD, 1 Euro cent for Euro, and 1 TL for TL. Moreover, it is possible to increase the range, and for all the virtual money within the range of each 10 USD, 10 Euro or 10 TL or their multiples to have the same code.

As each virtual money within said ranges has the same code, it is provided to determine the amount of money itself if the range is of 1 piastre, or the amount of virtual money which is equal to any amount at a range of 10 TL if it is of 10 TL range.

When the user wishes to spend her/his virtual money by using the equipment, s/he affixes/matches/brings close or connects the equipment to a device which will achieve said process and can communicate with the equipment (104). After the equipment and the device start to communicate, the amount corresponding to the shopping is entered into the device (105). The device checks whether the relevant amount is available within the equipment (106).

By interrogating whether the relevant amount is available in the equipment or not, it is tried to determine whether virtual money corresponding directly to the relevant amount is available. If an amount of money equal to the relevant amount is reached within the virtual deposit money corresponding to any real number starting from the infinitesimal (0.000°°1), the relevant amount of money is approved and the code corresponding to that amount is deleted from the equipment (107), and if there is virtual money corresponding to more than one same amount, one of them and the corresponding code is deleted once from the equipment.

If the virtual money totally equal to the relevant amount is not available within the equipment, the virtual money itself, which is equal to any of the 10 TL-range amounts is deleted (108). If there is virtual money corresponding to more than one relevant 10 TL-range, one of them and the corresponding code is deleted once from the equipment.

In the case that it is not equal to the relevant amount, the step 108 will be conducted as an equipment may not physically store the virtual money and codes thereof, which correspond to the amount, in all combinations of the shopping. Therefore, 1000 virtual money available inside the equipment to be used in the shopping equal to any amount between 1 piastre-10 TL and the codes thereof decrease one by one in each shopping of 1 piastre-10 TL.

In the case that virtual money corresponding to any amount up to 10 TL is loaded, 1000 different amounts will be available once in the equipment. However, in this case it will not be possible for the user to make shopping two times with an amount of 5 TL with the same equipment. The virtual money corresponding to the range of 1 piastre-10 TL and approving shopping can be loaded to an equipment with a quantity of 100. In this case, it is made possible, for the equipment to approve each shopping made 100 times with an amount of 5 TL.

As the virtual money equal to such certain ranges, corresponds to 10 TL-ranges increasing with the patterns of 10.01 TL-20.00 TL, 20.01 TL-30.00 TL, virtual money is made possible to be available so as to be equal to any amount in the equipment. For instance, 10 TL, and multiples thereof can be created in different types of currency and so as to cover different ranges starting from the infinitesimal. The possibilities may be determined depending on the preferences of the user and the authorities or on the frequency of circulation of such money on the market. Therefore, a range is determined without any maximum limit starting from the lowest denomination such as cent, piastre, etc. (or lower).

Therefore it becomes possible for a virtual deposit money which corresponds to a real number starting from the infinitesimal (0.000°°1 or 0.000, . . . 1) and which creates the ranges, to be used for making a payment.

Moreover, it is possible for the virtual deposit money equal to the amount necessary in any payment or money transfer to be available. The process can be conducted by using said amount directly for the process or by designating it for this process. Therefore, it will be possible to have a code corresponding to any currency. In other words, it is provided that the payment can be made independently from the amount by means of a single code without requiring a certain range. It is also possible to designate a code for any process independently from the amount.

In the case that the amount of the shopping requires more virtual money than the biggest amount within the equipment, it becomes possible to reach the relevant amount by using virtual money more than one in a way to correspond to the required amount.

1. A method of using virtual money that is created and used in shopping, characterized in it comprises the following process steps:
taking the equipment where the data regarding the amount, type, etc. of the virtual deposit money and the codes thereof will be saved, from the authority by the user;
freely determining the amount, type, number of the virtual money which will be available within the equipment, by the user and the authorized person;
creating a code independently from the amount of each virtual deposit money, without considering whether it corresponds to the same or different amount;
affixing/matching/bringing close or connecting the equipment to a device which will achieve said process and can communicate with the equipment, by the user when s/he wishes to spend her/his virtual deposit money by using the equipment;
entering the amount corresponding to the shopping into the device after the equipment and the device start to communicate;
checking whether the relevant amount is available within the equipment by the device; and
approving the relevant amount of money and deleting the code corresponding to that amount from the equipment if the amount of money is available corresponding to the relevant amount which is equal to any real number from the infinitesimal, and which creates the ranges.

2. A method of using virtual deposit money according to claim 1, characterized in that if the virtual money equal to the relevant amount is not available within the equipment, instead of the step where the relevant amount and code of money are deleted from the equipment; the step is conducted where the virtual deposit money itself, corresponding to any range of amount is approved, and the relevant amount is deleted from the equipment.

3. A method of using virtual deposit money according to claim 1, characterized by the step of using a code corresponding to any currency by using any virtual deposit money which is equal to the amount needed in each payment during shopping or in any process, directly for the process or by designating it for that process.

4. A method of using virtual deposit money according to claim 1, characterized in that a code is designated for any process independently from the amount.

5. A method of using virtual deposit money according to claim 1, characterized in that the step where when the amount of the shopping requires more virtual deposit money than the biggest amount within the equipment during the shopping, it becomes possible to reach the relevant amount by using virtual deposit money more than one in a way to correspond to the required amount or more.
